(19) United States
(12) Patent Application Publication
(10) Pub. No.: US 2006/0188672 A1
(43) Pub. Date: Aug. 24, 2006

(54) Thermal filtering insulation system

(76) Inventor: Keith R. Brower, Davenport, WA (US)

Correspondence Address: GREENBERG TRAURIG, 3773 HOWARD HUGHES PARKWAY, SUITE 500 NORTH, LAS VEGAS, NV, 89109, US

(21) Appl. No.: 11/061,199

(22) Filed: Feb. 18, 2005

(51) Int. Cl. B31B 45/00

(52) U.S. Cl. 428/34.1; 428/76

(57) ABSTRACT

A resistance/capacitance (RC) model thermal filtering system is disclosed. The resistance is provided by traditional insulation and the capacitance is provided by a phase change material (PCM). The RC model comprises the placement of a layer of PCM proximate an outer surface of a wall of an interior of a structure and the placement of a layer of traditional insulation adjacent the PCM. Accordingly, the PCM is placed between the wall and insulation. In this arrangement, heat energy absorbed by the PCM during peak hours of the day is routinely released to the interior (path of least resistance) of the structure during non-peak cooler times of the day. Packaging containing a matrix of pockets for containing a PCM compound facilitates a simple method of containing and placing the PCM layer. In one version, a containment medium is preferably perlite bound within a matrix with a sealing material, although other media can be employed for containing the phase change materials, such as vermiculite.

### FIELD OF THE INVENTION

The embodiments of the present invention relate to a thermal filtering insulation system utilizing conventional insulation material in combination with phase change material.

### BACKGROUND

Insulation has been utilized for decades to control the flow of tempered air. For example, insulation substantially prevents heat from flowing from a high temperature zone to a cool temperature zone. For example, the cool zone may be an interior of a structure such that the insulation helps maintain the cool internal temperature. Likewise, the interior temperature may be heated so that the insulation helps maintain the heated internal temperature. In otherwords, the insulation slows the rate of heat transfer.

Unfortunately, a change in either the inside or outside temperature is instantly reflected in the change in the rate of heat flow. Therefore, in order to maintain the desired internal temperature, the heating and cooling equipment must be able to respond quickly to changes in the temperature difference. Such is not always easy since the equipment must overcome a large volume of air or a large mass in the internal zone, both of which resist rapid temperature changes. Accordingly, during rapid external temperature fluctuations, the internal temperature is often either higher or lower than desired.

There lacks a method of maintaining a relatively constant rate of heat flow so as to maximize the efficiency of conventional heating and cooling equipment and to improve the correlation between the desired internal temperature and the actual internal temperature. Such a method would minimize the temperature variations and the energy output required to maintain a desired internal temperature.

Traditional forms of insulation comprise fiberglass rolls, batts, blankets and loose fill. Other types of insulation include cellulose, mineral wool and spray foam.

Materials known as phase change materials (“PCMs”) have also gained recognition as materials which, in combination with traditional insulation, reduce home heating or cooling loads, thereby producing energy savings for consumer.

PCMs are solid at room temperature but as the temperature increases the PCMs liquefy and absorb and store heat, thus potentially cooling an internal portion of a structure. Conversely, when the temperature decreases, the PCMs solidify and emit heat, thus potentially warming the internal portion of the structure. Consequently, by incorporating PCMs with traditional insulation materials, the PCMs absorb higher exterior temperatures during the day and dissipate the heat to the internal portion of the structure at night when it tends to be cooler. To date, such PCMs, if used at all, are installed between two layers of traditional insulation, such as fiberglass rolls or cellulose. Such an arrangement is known as Resistance/Capacitance/Resistance or RCR. The insulation acts to resist heat transfer thus providing the resistance while the PCM acts like a capacitor by storing energy

Known PCMs include paraffin compounds (linear crystalline alkyl hydrocarbons), sodium sulfate, fatty acids, salt hydrates and calcium chloride hexahydrate. While this list is not exhaustive, it is representative of the materials which exhibit properties common to PCMs.

The RCR model is disclosed in at least a handful of granted patents. More specifically, U.S. Pat. Nos. 5,626,936, 5,770,295 and 5,875,835 disclose RCR models formed of PCM and traditional insulation.

Although the benefits of RCR models are well-documented, the models suffer from one or more drawbacks, including the use of large quantities of PCM and the inability to reduce cooling loads at extreme temperatures. For example, during daytime highs, the ceiling drywall of a structure can reach temperatures in excess of 80°. Even with the RCR model in place in the attic, a portion of the heat energy reaches the interior room(s) thereby requiring an increase in cooling load to maintain a comfortable room temperature. Thus, there continues to be a need for a more efficient system which combines PCMs and traditional insulation. Specifically, the need comprises a system for reducing spikes in the required cooling load.

### SUMMARY

Accordingly, a first embodiment of the present invention comprises PCMs in combination with a single layer of traditional insulation (i.e., Resistance/Capacitance or RC). In this model, PCM is placed between an outer surface of a wall of an interior of a structure and a single layer of traditional insulation. In this configuration, there is a maximum amount of insulation between the PCM and the exterior of the structure. Besides drywall, there is virtually no insulation between the PCM and the interior of the structure. As set forth in greater detail below, this model reduces the amount of PCM required by the RCR model and eliminates cooling load spikes common with the RCR model.

As described below, the RC model of the present invention is facilitated by reflective packaging which contains the PCM in a plurality of individual compartments or pockets.

In a second embodiment, the reflective packaging containing the PCM is used as a radiant barrier sheet. In this embodiment, the reflective packing containing the PCM is placed between roof decking and a ceiling alone or in proximity to insulation.

Other advantages, objects, variations and embodiments of the present invention will be readily apparent from the following drawings, detailed description, abstract and claims.

### BRIEF DESCRIPTION OF THE DRAWINGS

FIG. 1 shows a cross-sectional view of a wall supporting a PCM sandwiched between traditional insulation (i.e., the RCR model);

FIG. 2 shows a cross-sectional view of a wall supporting a PCM and one layer of traditional insulation (i.e., the RC model);

FIG. 3 shows PCM contained within a reflective packaging; and

FIG. 4 shows a first configuration of the reflective packaging containing the PCM acting as a radiant barrier;

FIG. 5 shows a second configuration of the reflective packaging containing the PCM acting as a radiant barrier; and

FIG. 6 shows a third configuration of the reflective packaging containing the PCM acting as a radiant barrier.

### DETAILED DESCRIPTION

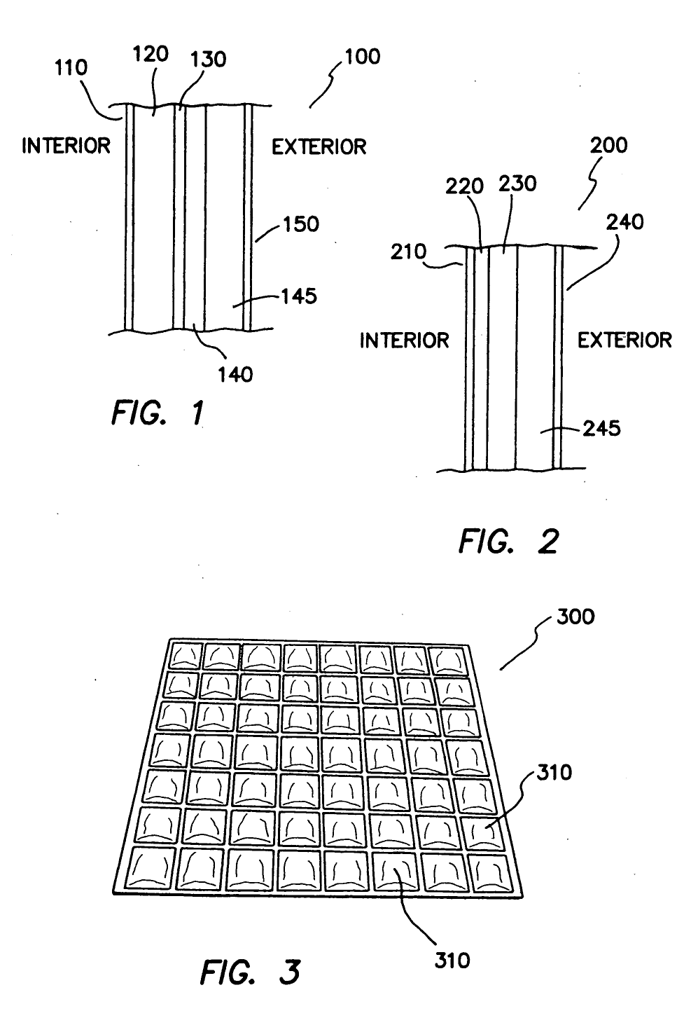

Reference is now made to the figures wherein like parts are referred to by like numerals throughout. FIG. 1 shows a cross-sectional view of a prior art embodiment of the RCR model generally referred to as reference numeral 100. The cross-section comprises an interior drywall 110, first insulation layer 120, PCM 130, second insulation layer 140 and exterior wall portion 150.

In the arrangement shown in FIG. 1, the PCM 130 collects heat energy which is primarily dissipated to the external environment. The RCR model 100 shown comprises a first insulation layer 120 having twice the insulation as the second insulation layer 140. With this arrangement, when the outside temperature rises above the PCM transition temperature (e.g., 80°), the heat energy exceeding the transition temperature and moving through insulation layer 140 is absorbed by the PCM 130. If the PCM 130 is below the transition temperature, the PCM temperature quickly rises to the transition temperature and melts as it continues to absorb the heat energy. During this heat absorption, any remaining solid PCM 130 maintains the liquid PCM at the approximate transition temperature of the PCM 130. Therefore, between the PCM 130 and the interior of the structure, the ΔT (i.e., the difference in temperature) is generally small. For example, a room temperature of 73° F. and a PCM transition temperature of 80° F. results in a ΔT of 7° F. In addition, insulation layer 120 is twice as thick as that of insulation layer 140. Accordingly, during the evening as ambient temperatures drop below the transition temperature, the liquid PCM freezes as it releases energy. The released energy takes the path of least resistance such that it is released through the thinner insulation layer 140 and into the external environment.

It is noted that space 145 is between the exterior wall portion 150 and the insulation layer 140. This arrangement mimics an attic. However, with other walls, the space 145 may be reduced or eliminated.

FIG. 2 shows a cross-sectional view of a RC model 200 of the present invention. The cross-section comprises an interior drywall 210, PCM 220, insulation layer 230 and exterior wall portion 240. Similarly, to FIG. 1, there is shown a space 245 is between the exterior wall portion 240 and the insulation layer 230. This arrangement mimics an attic. However, with other walls, the space 245 may be reduced or eliminated.

With the RC model, PCM 220 is placed between a wall of an interior of the structure and a single layer of insulation 230. In this configuration, there is a layer of insulation 230 between the PCM 220 and the exterior of the structure. Other than the small insulation value of the interior drywall 210, there is virtually no insulation between the PCM 220 and the interior of the structure. It is noted that other wall materials, such as sheet rock, do not provide significant insulation either. In this arrangement, relative to the RCR model, the amount of required PCM 220 is reduced since less heat reaches the PCM 220. Moreover, the interior of the structure is typically below the transition temperature of the PCM 220 resulting in a continuous flow of transition temperature heat into the interior of the structure. Consequently, the RC model causes most of the heat energy absorbed by the PCM 220 to flow to the interior of the structure at the transition temperature thereby maintaining a manageable flow of heat energy to the interior of the structure. In other words, the heat energy flow is systematic and at the transition temperature so that the required cooling load remains flat.

As noted above, the RCR model 100 is able to maintain 100% or less of the transition temperature between the exterior and the interior of the structure during a day cycle. To do so, the following conditions must be met: 1) the amount and type of PCM must be adequate so it does not completely melt in response to the amount of heat energy is it expected to absorb and 2) the ΔT the PCM is subjected to is comparable on both the heat-up and cool-down cycle or there is a corresponding increase in cooling time when the ΔT is smaller during the cool-down segment of the cycle. The RCR model 100 provides some measure of energy transference away from the interior of the structure so long as the exterior temperature drops below the transition temperature for a satisfactory period of time.

Similarly, the RC model 200 is able to maintain 100% or less of the transition temperature between the exterior and the interior of the structure during a day cycle as well, but the heat energy is released into the interior of the structure. The difference between the RC model 200 and mass-enhanced R-values is that the stored energy is released at the transition temperature instead of an elevated specific heat temperature. To do so, the following conditions must be met: 1) the amount and type of PCM must be adequate so it does not completely melt in response to the amount of heat energy is it expected to absorb and 2) the ΔT between the interior of the structure and the PCM must be great enough to remove the stored heat in the PCM during the temperature swings of the day cycle. One of the primary advantages of the RC model 200 is that it operates at 100% PCM capacity for a cooling conditioned structure regardless of extreme climate fluctuations. The RC model 200 maintains a flat cooling load thereby eliminating cooling spikes and facilitating load shifting power demand.

A method of creating the RC model comprises the placement of a thin hermetic sheet containing a PCM compound in an attic on the drywall between the ceiling joists. The hermetic sheet is then covered with traditional insulation. With the PCM in place, the interior of the structure is protected from ceiling temperatures in excess of the transition (e.g., 80°) as the heat energy absorbed by the PCM is dissipated during the lower temperature times of the day.

As shown in FIG. 3, the hermetic sheet 300 developed by the inventors hereof comprises an easily folded hermetic poly/foil/poly packaging formed by a plurality of sealed pockets 310 in a matrix configuration. The pockets 310 contain one or more possible PCM compounds. An ideal PCM compound formed with perlite is described in detail below. The packaging material has uniform thermal conductivity properties for ensuring a significant capture of heat energy. The matrix configuration of the pockets 310 permit the packaging to be cut into any number of necessary dimensions. The sheets are also lightweight, weighing less than ¾ lb. per sq. ft.

In one embodiment, the PCM compound comprises a mixture of a suitable PCM and a containment medium for containing the PCM. The containment medium is preferably perlite bound within a matrix with a sealing material, although other media can be employed for containing the phase change materials, such as vermiculite. Perlite is a naturally occurring volcanic glass which can be expanded to form an insulating material having many voids. In this manner, the PCM is absorbed in voids in the perlite. The details of making and using this and other suitable PCM compounds are fully set forth in U.S. Pat. No. 5,875,835 to Shramo and assigned to Phase Change Technologies, Inc., and incorporated herein by this reference.

The PCM compound prevents the migration of liquid in the event that the packaging is compromised, eliminates inconsistent phase change due to congruency or supercooling problems and prevents large crystal growth. The prevention of large crystal growth further prevents packaging erosion which results from repeated freezing and thawing events.

In practice, the placement of the hermetic sheet 300 as described above facilitates the following process. Daytime weather may cause the ceiling drywall to reach temperatures in excess of 80° F. During this period, heat energy reaching the interior of the structure with temperatures above 80° F. would normally result in an increased cooling load. However, in this case the heat energy is absorbed by the PCM. As the peak ambient temperature falls and the PCM temperature falls below the transition temperature (e.g., 80° F.), the PCM releases the 80° F. energy it absorbed to the interior of the structure. Therefore, the PCM releases the heat energy after the daytime peak heating period and the structure's cooling system does have to accommodate temperatures above 80° F. emanating from the attic. Importantly, the RC model 200 maintains a felt temperature at the ceiling below 80° F.

The reflective nature of the PCM compound packaging reflects infrared heat further maintaining the ceiling temperature below 80° F. and maximizing the effects of the PCM.

In a second embodiment, the reflective packaging and contained PCM is used as a conventional radiant barrier. In past systems, a layer or sheet of reflective material, such as foil, is placed between roof decking and interior space of a building. As known to those skilled in the art, the sheet of reflective material reflects infrared heat thereby decreasing the amount of heat which would otherwise reach the interior space of the building. However, the use of the reflective material containing the PCM enhances the process by continuing to reflect heat while absorbing additional heat. In this manner, the effect of the reflective packaging is enhanced.

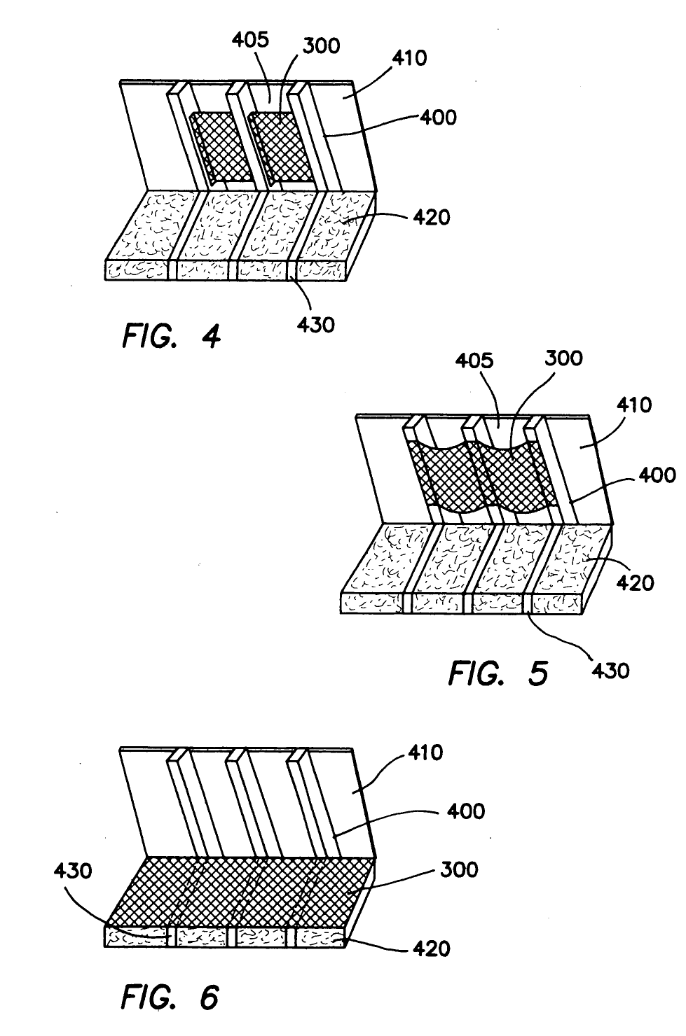

In practice, the installation of the reflective packaging and contained PCM can take different configurations. FIGS. 4-6 show three such possible configurations. Specifically, FIG. 4 shows the reflective packaging or hermetic sheet 300 placed between ceiling rafters 400 and beneath roof decking 410. In this, configuration there may or may not be a space 405 between the sheet 300 and the roofing deck 410. FIG. 5 shows the reflective packaging or hermetic sheet 300 placed on the ceiling rafters 400 thereby creating a space 405 between the roof decking 410 and the sheet 300. FIG. 6 shows the reflective packaging or hermetic sheet 300 placed on top of or adjacent to conventional insulation 420 between ceiling joists 430. In each of the configurations, the conventional insulation 420 is typically placed between the ceiling joists 430.

Although the invention has been described in detail with reference to several embodiments, additional variations and modifications exist within the scope and spirit of the invention as described and defined in the following claims.

I claim:

1. A thermal insulation system comprising:
a phase change material contained within packaging, said phase change material placed proximate to an outer surface of a wall of an interior of a structure wherein substantially no insulation is placed between the phase change material and the outer surface of the wall of the interior of the structure; and
an insulation layer placed adjacent to said phase change material such that said phase change material is between the wall of the interior of the structure and the insulation layer.

2. The system of claim 1 wherein the packaging comprises a plurality of separate compartments for containing phase change material.

3. The system of claim 1 wherein the phase change material is combined with perlite bound within a matrix with a sealing material.

4. The system of claim 1 wherein the phase change material is selected from the group consisting of paraffin compounds, sodium sulfate and calcium chloride hexahydrate.

5. The system of claim 1 wherein the insulation layer is selected from the group consisting of fiberglass, loose fill, cellulose, mineral wool and spray foam.

6. The system of claim 1 wherein the phase change material is contained within a poly/foil/poly packaging material.

7. The system of claim 1 wherein the phase change material is placed adjacent to an outer surface of an attic wall.

8. A thermal insulation system comprising:
a phase change material combined with perlite bound within a matrix with a sealing material contained within packaging, said phase change material combination placed adjacent to an outer surface of a wall of an interior of a structure wherein substantially no insulation is placed between the phase change material and the outer surface of the wall of the interior of the structure; and
an insulation layer placed over said phase change material such that said phase change material is between the wall of the interior of the structure and the insulation layer.

9. The system of claim 8 wherein the packaging comprises a plurality of individual pockets for containing phase change material.

10. The system of claim 8 wherein the phase change material is selected from the group consisting of salt hydrates, paraffin compounds and fatty acids.

11. The system of claim 8 wherein the insulation layer is selected from the group consisting of fiberglass, loose fill, cellulose, mineral wool and spray foam.

12. The system of claim 8 wherein the phase change material is contained within a poly/foil/poly packaging material.

13. The system of claim 8 wherein the phase change material combination is placed adjacent to an outer surface of an attic wall.

14. A method of thermally insulating an interior of a structure comprising:
enclosing phase change material in a packaging material;
positioning the packaging material adjacent to an outer surface of a wall of an interior of a structure such that substantially no insulation is between the packaging material and the outer surface of the wall; and
positioning a layer of insulation proximate the packaging material such that the packaging material is between the wall and the insulation.

15. The method of claim 14 further comprising forming a plurality of individual pockets in the packaging material, said pockets for containing the phase change material.

16. The method of claim 14 further comprising fabricating poly/foil/poly type of packaging material.

17. The method of claim 14 wherein the packaging material and the layer of insulation are positioned in an attic of the structure.

18. A method of thermally insulating an interior of a structure comprising:
enclosing phase change material in a plurality of individual pockets of a packaging material;
positioning the packaging material against an outer surface of a wall of an interior of a structure such that substantially no insulation is between the packaging material and the outer surface of the wall; and
positioning a layer of insulation over the packaging material such that the packaging material is between the wall and the insulation.

19. The method of claim 18 further comprising fabricating poly/foil/poly type of packaging material.

20. The method of claim 18 wherein the packaging material and the layer of insulation are positioned in an attic of a structure.

21. A thermal insulation system comprising:
a phase change material contained within a reflective packaging, said phase change material placed between a roof decking of a structure and a ceiling of a structure; and
an insulation layer placed proximate the ceiling of the structure.

22. The thermal insulation system of claim 21 wherein the reflective packaging is placed between rafters supporting the roof decking.

23. The thermal insulation system of claim 21 wherein the reflective packaging is placed over rafters supporting the roof decking.

24. The thermal insulation system of claim 21 wherein the reflective packaging is placed adjacent to the insulation layer.

25. A method of thermally insulating an interior of a structure comprising:
positioning reflective packaging containing phase change material between a roof decking of a structure and a ceiling of a structure; and
positioning an insulation layer proximate the ceiling of the structure.

26. The thermal insulating method of claim 25 further comprising positioning the reflective packaging between rafters supporting the roof decking.

27. The thermal insulating method of claim 25 further comprising positioning the reflective packaging over rafters supporting the roof decking.

28. The thermal insulating method of claim 25 further comprising positioning the reflective packaging adjacent to the insulation layer.
